(19) United States
(12) Patent Application Publication
(10) Pub. No.: US 2011/0052874 A1
(43) Pub. Date: Mar. 3, 2011

(54) ROOFING ARTICLES WITH HIGHLY REFLECTIVE COATED GRANULES

(76) Inventors: Wensheng ZHOU, Carmel, IN (US); Joseph Standeford, Indianapolis, IN (US); Ruben Garcia, Westfield, IN (US); Jill Logan, Carmel, IN (US)

(21) Appl. No.: 12/829,732

(22) Filed: Jul. 2, 2010

Related U.S. Application Data
(60) Provisional application No. 61/222,692, filed on Jul. 2, 2009.

(51) Int. Cl. B32B 3/10

(52) U.S. Cl. 428/148; 428/143; 428/150

(57) ABSTRACT

A roofing article comprising an asphaltic substrate; and a plurality of granules disposed on a surface of the substrate, said granules including a base rock and a coating, where the coating is characterized by a reflectivity, according to ASTM C1549, of at least 50%, an opacity of at least 50%, and is chemically inert, and where the base rock is characterized by a reflectivity of at least 50%, an opacity of at least 50%, and is chemically inert.

This application claims the benefit of U.S. Provisional Application Ser. No. 61/222,692, filed on Jul. 2, 2009, and is incorporated herein by reference.

### FIELD OF THE INVENTION

Embodiments of the present invention are directed toward roofing articles that carry highly reflective coated granules.

### BACKGROUND OF THE INVENTION

Asphaltic roofing membranes have been employed to cover flat or low-sloped roofs. These membranes are typically installed by unrolling a roll of material on a roof surface and then heat seaming adjacent membranes together to form an impervious water barrier on the roof surface.

As part of the manufacturing process, the asphaltic roofing membranes are often coated with granular material. Among the benefits associated with the use of these granules is the ability to reflect solar radiation, including infrared radiation, and thereby maintain a cooler roof surface. It is believed that by increasing the reflectivity of the roofing surface, energy savings can be achieved. There is, therefore, a desire to increase the reflectivity of roofing surfaces, particularly those that are covered with asphaltic membrane.

### SUMMARY OF THE INVENTION

One or more embodiments of the present invention provide a roofing article comprising an asphaltic substrate; and a plurality of granules disposed on a surface of the substrate, said granules including a base rock and a coating, where the coating is characterized by a reflectivity, according to ASTM C1549, of at least 50%, an opacity of at least 50%, and is chemically inert, and where the base rock is characterized by a reflectivity of at least 50%, an opacity of at least 50%, and is chemically inert.

### BRIEF DESCRIPTION OF THE DRAWINGS

FIG. 1 shows roofing granules with a highly reflective base rock coated with a highly reflective coating.

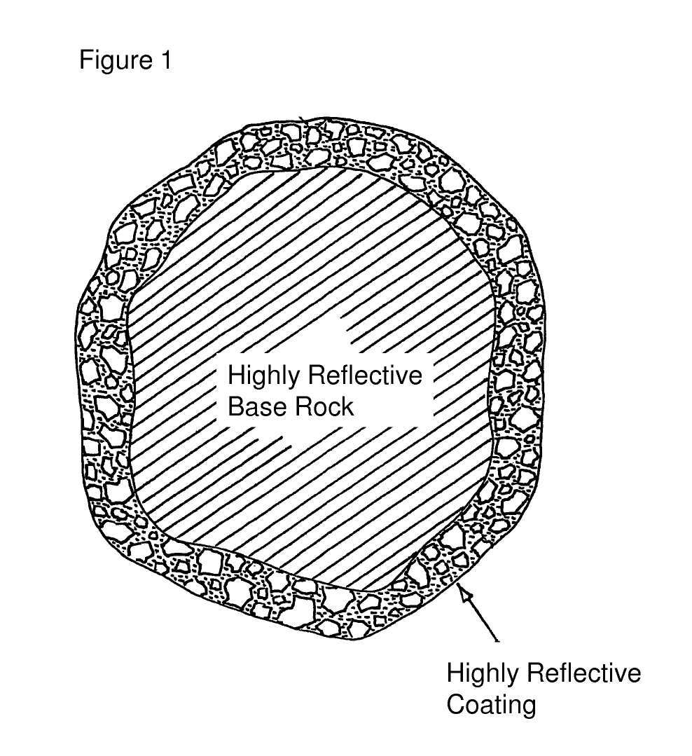

### DETAILED DESCRIPTION OF ILLUSTRATIVE EMBODIMENTS

Embodiments of the invention are based, at least in part, on the discovery of an asphaltic roofing membrane having a panel reflectivity, according to ASTM C1549, of at least 65%. The roofing membrane includes coated granules that include a base rock and a coating on the base rock. While the prior art may have suggested the use of coated granules, it has not been unexpectedly discovered that the characteristics of the base rock are critical to achieving a panel reflectivity of at least 65%.

As is understood in the art, panel reflectivity refers the reflectivity, as measured according to ASTM C1549, of an asphaltic membrane, which includes a substantially black substrate and granules deposited over at least 95% of one planar surface of the substrate. Reference may also be made to the reflectivity of the coated granules, the base rock, or the coating on the base rock. As those skilled in the art appreciate, coated granule and base rock reflectivity refer to the reflectivity of the granules or rocks themselves as may be provided in an appropriate sample which may include about an inch of material in depth; in other words, the sample is provided in sufficient thickness so as to minimize or eliminate any reduction in reflectivity that may be caused by a substrate on which the granules or rocks may be placed.

### Asphaltic Substrate

Practice of the present invention is not necessarily limited by the choice of asphaltic substrate. Any asphaltic substrate currently used in the roofing art can be used in practice of the present invention. In particular embodiments, the substrate includes a roofing shingle, which is conventionally used on residential buildings with relatively high-sloped roofs. In other embodiments, the asphaltic substrate includes modified asphalt membranes, which includes those membranes that are conventionally used on commercial buildings that have flat or low-sloped roofs. Examples of modified asphalt membranes are disclosed in U.S. Pat. Nos. 6,492,439, 6,486,236, 4,835,199, 7,442,270, 7,146,771, 7,070,843, 4,992,315, and 6,924,015, which are incorporated herein by reference.

As is generally known, the roofing articles are generally planar structures. For example, modified asphalt membranes are generally in the form of a sheet that is rolled for storage and transport. Upon installation, these sheets are unrolled and adjacent sheets can be heat welded together to form a water-impervious barrier on the top of the roof. In a manner similar to conventional practice, a planar surface of the membrane is coated with granules. The coated surface is typically the surface that is exposed to the environment when installed on a roof, and therefore it may be referred to as the top surface. The opposite planar surface, which may be referred to as the bottom surface, is typically not coated with granules and therefore may be devoid or substantially devoid of granules.

In one or more embodiments, the roofing articles of the present invention have at least one planar surface that is substantially covered by granules. In one or more embodiments, at least 95%, in other embodiments at least 96%, in other embodiments at least 97%, in other embodiments at least 98%, in other embodiments at least 99%, and in other embodiments at least 99.5% of the surface area of at least one planar surface of the asphaltic substrate is covered with granules.

### Granules

As noted above, the granules include a base rock, which may also be referred to as a base granule, and a coating that at least partially covers the base rock.

In one or more embodiments, the granules (i.e. coated base rock) are characterized by reflectivity, according to ASTM C1549, of at least 65%, in other embodiments at least 68%, in other embodiments at least 70%, in other embodiments at least 72%, and in other embodiments at least 75%.

In one or more embodiments, the granules (i.e. coated base rock) are characterized by a panel reflectivity, according to ASTM C1549, of at least 65%, in other embodiments at least 68%, in other embodiments at least 70%, in other embodiments at least 72%, and in other embodiments at least 75%.

In one or more embodiments, the difference between the granule (i.e. coated base rock) reflectivity and the panel reflectivity of the granules (i.e. coated base rock) is less than 15%, in other embodiments less than 12%, in other embodiments less than 10%, in other embodiments less than 8%, and in other embodiments less than 5%. It is believed that the differential between the reflectivity of the granules and the panel reflectivity provided by the granules (i.e. coated base rock) is indicative of the opacity of the granules (i.e. coated base rock).

In one or more embodiments, the granules (i.e. coated base rock) are characterized by being white in color. In one or more embodiments, the granules have an L* value of at least 50, in other embodiments at least 60, in other embodiments at least 70, in other embodiments at least 75, in other embodiments at least 80, in other embodiments at least 85, in other embodiments at least 90, in other embodiments at least 91, in other embodiments at least 92, in other embodiments at least 93, in other embodiments at least 94, and in other embodiments at least 95. As those skilled in the art appreciated, the Color of granules may be measured to determine L-value by using standard instrumentation such as Hunter L,a,b (Hunter Associates Laboratory, Inc., Reston, Va.) or CIELAB. Values for “L*” indicate the ratio of light to dark. Values for “a” refer to the redness-greenness coordinate in certain transformed color spaces, generally used as the difference in “a” between a specimen and a standard reference color. If “a” is positive, there is more redness than greenness; if “a” is negative, there is more greenness than redness. It is normally used with b as part of the chromaticity or chromaticity color difference. Values for “b” refer to the yellowness-blueness coordinate in certain color spaces, generally used as the difference in “b” between a specimen and a standard reference color, normally used with “a” or a as part of the chromaticity difference. Generally, if “b” is positive, there is more yellowness than blueness; if “b” is negative, there is more blueness than yellowness. For a description of the Hunter Color test methods, see Billmeyer, Jr. et al., PRINCIPLES OF COLOR TECHNOLOGY, John Wiley & Sons, 2^{ED} (1981), which is incorporated herein by reference.

In one or more embodiments, the granules (i.e. coated base rock) are characterized by an opacity to visible light (i.e. visible light that is blocked by the base rock) of at least 50%, in other embodiments at least 60%, in other embodiments at least 70%, in other embodiments at least 80%, in other embodiments at least 90%, in other embodiments at least 93%, in other embodiments at least 95%, and in other embodiments at least 97% (e.g., the coated rock blocks 97% of visible light). In these or other embodiments, the coated rock has similar opacity to UV and Infrared electromagnetic radiation. In these or other embodiments, granules are characterized by an opacity to terrestrial solar radiation of at least 50%, in other embodiments at least 60%, in other embodiments at least 70%, in other embodiments at least 80%, and in other embodiments at least 90%, in other embodiments at least 93%, in other embodiments at least 95%, and in other embodiments at least 97% (e.g., the coated rock blocks 97% of terrestrial solar radiation).

In one or more embodiments, the granules (i.e. coated base rock) are characterized as being chemically inert, which refers to the fact that the coated rock is stable to chemical conditions conventionally experienced on a roof surface. In one or more embodiments, the coated rock is insoluble in water, which refers to a solubility of 0.01 gram per liter or less at standard conditions of temperature and pressure and a pH of 7. In one or more embodiments, the coated rock is insoluble in water under acidic conditions, which refers to a solubility of 0.01 gram per liter or less at standard conditions of temperature and pressure and a pH of 5 or less, or in other embodiments at a pH of 4 or less, or in other embodiments at a pH of 3 or less, or in other embodiments at a pH of 2 or less. In these or other embodiments, the granules are insoluble in water under basic conditions, which refers to a solubility of 0.01 gram per liter or less at standard conditions of temperature and pressure and a pH of 8 or more, or in other embodiments at a pH of 9 or more, or in other embodiments at a pH of 10 or more, or in other embodiments at a pH of 11 or more.

In one or more embodiments, the base rocks are characterized by a number average particle size of from about −3½ to about +70 mesh, or in other embodiments from about −4 to about +35 mesh. In other words, the particles, on average, are of sufficient size so that 90% or more of the material will pass through a 3½-mesh sieve (particles smaller than 5.66 mm) and be retained by a 70-mesh sieve (particles larger than 0.210 mm).

In one or more embodiments, the base rocks are characterized by an number average particle size of less than 10 mm, in other embodiments less than 3 mm, in other embodiments less than 1 mm, and in other embodiments less than 850 microns. In these or other embodiments, the base rocks are characterized by an average particle size of at least 200 microns, in other embodiments at least 500 microns, and in other embodiments at least 800 microns.

In one or more embodiments, the base rocks are characterized by an opacity to visible light of at least 10%, in other embodiments at least 25%, in other embodiments at least 35%, in other embodiments at least 50%, in other embodiments at least 60%, in other embodiments at least 70%, in other embodiments at least 80%, and in other embodiments at least 90%, in other embodiments at least 93%, in other embodiments at least 95%, and in other embodiments at least 97% (e.g., they block 97% of visible light). In these or other embodiments, the base rock has similar opacity to UV and Infrared electromagnetic radiation. In these or other embodiments, the base rock is characterized by an opacity to terrestrial solar radiation of at least 10%, in other embodiments at least 25%, in other embodiments at least 35%, in other embodiments at least 50%, in other embodiments at least 60%, in other embodiments at least 70%, in other embodiments at least 80%, and in other embodiments at least 90%, in other embodiments at least 93%, in other embodiments at least 95%, and in other embodiments at least 97% (e.g., they block 97% of visible light).

In one or more embodiments, the base rocks are characterized by reflectivity, according to ASTM C1549, of at least 65%, in other embodiments at least 68%, in other embodiments at least 70%, in other embodiments at least 72%, and in other embodiments at least 75%.

In one or more embodiments, the base rocks are characterized by a panel reflectivity, according to ASTM C1549, of at least 65%, in other embodiments at least 68%, in other embodiments at least 70%, in other embodiments at least 72%, and in other embodiments at least 75%.

In one or more embodiments, the difference between the base rock reflectivity and the panel reflectivity of the base rocks (i.e. uncoated) is less than 15%, in other embodiments less than 12%, in other embodiments less than 10%, in other embodiments less than 8%, and in other embodiments less than 5%. It is believed that the differential between the reflectivity of the base rock and the panel reflectivity provided by the base rock (i.e. uncoated) is indicative of the opacity of the base rock.

In one or more embodiments, the base rock is characterized by being white in color. In one or more embodiments, the base rock has an L* value of at least 50, in other embodiments at least 60, in other embodiments at least 70, in other embodiments at least 75, in other embodiments at least 80, in other embodiments at least 85, in other embodiments at least 90, in other embodiments at least 91, in other embodiments at least 92, in other embodiments at least 93, in other embodiments at least 94, and in other embodiments at least 95. As those skilled in the art appreciated, the Color of base rock may be measured to determine L-value by using standard instrumentation such as Hunter L,a,b (Hunter Associates Laboratory, Inc., Reston, Va.) or CIELAB. Values for “L*” indicate the ratio of light to dark. Values for “a” refer to the redness-greenness coordinate in certain transformed color spaces, generally used as the difference in “a” between a specimen and a standard reference color. If “a” is positive, there is more redness than greenness; if “a” is negative, there is more greenness than redness. It is normally used with b as part of the chromaticity or chromaticity color difference. Values for “b” refer to the yellowness-blueness coordinate in certain color spaces, generally used as the difference in “b” between a specimen and a standard reference color, normally used with “a” or a as part of the chromaticity difference. Generally, if “b” is positive, there is more yellowness than blueness; if “b” is negative, there is more blueness than yellowness. For a description of the Hunter Color test methods, see Billmeyer, Jr. et al., PRINCIPLES OF COLOR TECHNOLOGY, John Wiley & Sons, 2^{ED} (1981), which is incorporated herein by reference.

In one or more embodiments, the base rock is characterized as being chemically inert, which refers to the fact that the base rock is stable to chemical conditions conventionally experienced on a roof surface. In one or more embodiments, the base rock is insoluble in water, which refers to a solubility of 0.01 gram per liter or less at standard conditions of temperature and pressure and a pH of 7. In one or more embodiments, the base rock is insoluble in water under acidic conditions, which refers to a solubility of 0.01 gram per liter or less at standard conditions of temperature and pressure and a pH of 5 or less, or in other embodiments at a pH of 4 or less, or in other embodiments at a pH of 3 or less, or in other embodiments at a pH of 2 or less. In these or other embodiments, the base rock is insoluble in water under basic conditions, which refers to a solubility of 0.01 gram per liter or less at standard conditions of temperature and pressure and a pH of 8 or more, or in other embodiments at a pH of 9 or more, or in other embodiments at a pH of 10 or more, or in other embodiments at a pH of 11 or more.

In one or more embodiments, the base rock is characterized by an aluminum oxide (Al₂O₃) content of less than 55%, in other embodiments less than 50%, and in other embodiments less than 45%. In these or other embodiments, the base rock is characterized by an aluminum oxide (Al₂O₃) content of at least 35%, in other embodiments at least 40%, and in other embodiments at least 42%. In these or other embodiments, the base rock is characterized by a silicon dioxide (SiO₂) content of less than 65%, in other embodiments less than 60%, and in other embodiments less than 55%. In these or other embodiments, the base rock is characterized by a silicon dioxide (SiO₂) content of at least 40%, in other embodiments at least 45%, and in other embodiments at least 49%. In one or more embodiments, the base rock is a refractory material sold under the name Mullite 45. In other embodiments, the base rock is crushed porcelain.

In other embodiments, the base rock is characterized by an aluminum oxide (Al₂O₃) content of less than 85%, in other embodiments less than 80%, and in other embodiments less than 75%. In these or other embodiments, the base rock is characterized by an aluminum oxide (Al₂O₃) content of at least 55%, in other embodiments at least 65%, and in other embodiments at least 70%. In these or other embodiments, the base rock is characterized by a silicon dioxide (SiO₂) content of less than 35%, in other embodiments less than 30%, and in other embodiments less than 27%. In these or other embodiments, the base rock is characterized by a silicon dioxide (SiO₂) content of at least 10%, in other embodiments at least 15%, and in other embodiments at least 20%. In one or more embodiments, the base rock is a refractory material sold under the name Mullite M60 (GMRC).

In other embodiments, the base rock is crushed porcelain. In other embodiments, the base rock is calcium oxide. In other embodiments, the base rock is alumina. In other embodiments, the base rock is tabular alumina. In other embodiments, the base rock is grog or recycled alumina scrap from fire brick and kiln furnaces.

In one or more embodiments, the coating is characterized by a thickness of from about 1 to about 100 microns, in other embodiments from about 2 to about 50 microns, in other embodiments from about 8 to about 25 microns, or in other embodiments from about 10 to about 20 microns. In these or other embodiments, the coating has a thickness of less than 80 microns, in other embodiments less than 50 microns, in other embodiments less than 40 microns, in other embodiments less than 30 microns, and in other embodiments less than 20 microns. In these or other embodiments, the coating has a thickness of at least 1 micron, in other embodiments at least 2 microns, in other embodiments at least 5 microns, and in other embodiments at least 10 microns.

In one or more embodiments, the coating is characterized by an opacity, which for purposes of this specification referrers to the level of visible light that is blocked by the coating, of at least 10%, in other embodiments at least 25%, in other embodiments at least 35%, in other embodiments at least 50%, in other embodiments at least 60%, in other embodiments at least 70%, in other embodiments at least 80%, and in other embodiments at least 90% (e.g., the coating blocks 90% of visible light). In these or other embodiments, the coating has similar opacity to UV and Infrared electromagnetic radiation. In these or other embodiments, the coating is characterized by an opacity to terrestrial solar radiation of at least 10%, in other embodiments at least 25%, in other embodiments at least 35%, in other embodiments at least 50%, in other embodiments at least 60%, in other embodiments at least 70%, in other embodiments at least 80%, and in other embodiments at least 90% (e.g., the coating blocks 90% of terrestrial solar radiation).

In one or more embodiments, the coating is characterized by a visible light (about 400 to about 700 nm) reflectivity of at least 50%, in other embodiments at least 60%, in other embodiments at least 70%, in other embodiments at least 80%, and in other embodiments at least 90%. In one or more embodiments, the coating is characterized by a UV electromagnetic radiation (about 10 nm to about 400 nm) reflectivity of at least 50%, in other embodiments at least 60%, in other embodiments at least 70%, in other embodiments at least 80%, and in other embodiments at least 90%. In one or more embodiments, the coating is characterized by an infrared electromagnetic radiation (about 700 nm to about 10⁻³ m) reflectivity of at least 50%, in other embodiments at least 60%, in other embodiments at least 70%, in other embodiments at least 80%, and in other embodiments at least 90%. In one or more embodiments, the coating is characterized by a terrestrial solar radiation (about 250 nm to about 2500 nm) reflectivity of at least 50%, in other embodiments at least 60%, in other embodiments at least 70%, in other embodiments at least 80%, and in other embodiments at least 90%. For purposes of this specification, terrestrial solar radiation refers to the solar radiation contacting sea level.

In one or more embodiments, the coating is characterized as being chemically inert, which refers to the fact that the coating is stable to chemical conditions conventionally experienced on a roof surface. In one or more embodiments, the coating is insoluble in water, which refers to a solubility of 0.01 gram per liter or less at standard conditions of temperature and pressure and a pH of 7. In one or more embodiments, the coating is insoluble in water under acidic conditions, which refers to a solubility of 0.01 gram per liter or less at standard conditions of temperature and pressure and a pH of 5 or less, or in other embodiments at a pH of 4 or less, or in other embodiments at a pH of 3 or less, or in other embodiments at a pH of 2 or less. In these or other embodiments, the coating is insoluble in water under basic conditions, which refers to a solubility of 0.01 gram per liter or less at standard conditions of temperature and pressure and a pH of 8 or more, or in other embodiments at a pH of 9 or more, or in other embodiments at a pH of 10 or more, or in other embodiments at a pH of 11 or more.

Practice of the present invention is not necessarily limited by the type of coating or the method by which the coating is applied to the base rock. Conventional compositions and procedures for coating rocks or granules may be used including those compositions and methods used to impart coatings or color to granules used on roofing shingles. These compositions and methods include those disclosed in U.S. Pat. Nos. 4,359,505, 7,641,959, and Publication No. 2007/0065640, which are incorporated herein by reference.

In one or more embodiments, the coating includes pigment and a silicate/clay matrix. For example, the coating composition may contain a soluble alkali silicate binder that is insolubilized by heat treatment or by chemical action or a combination thereof. Insolubilization by chemical action typically involves the addition of an acidic material to the soluble alkali silicate after heat treatment.

In one or more embodiments, the base rock is coated with a semi-ceramic composition that may include a uniform, homogeneous, fired, silicate-clay matrix comprising: (a) pigments to impart color to the coating and/or to maximize reflection of the IR portion of incident solar radiation; and/or (b) coarse, non-pigmentary titanium dioxide particles distributed throughout the coating, which may be used to reflect transmitted IR radiation not reflected by the pigments.

In one or more embodiments, the pigment may include dark IR-reflective pigments. The pigments may be used in amounts ranging from 10 PPT to 40 PPT. These pigments may include mixed metal oxide types that include, but are not limited to, the following generic groups: Zinc Iron Chromite, Brown Spinel, Iron Titanium Brown Spinel, Chromium Green Black Hematite, Chromium Iron Oxide, Chromium Iron Nickel Black Spinel, Cobalt Chromium Green Spinel, Chromium Titanate Green Spinel, Cobalt Aluminate Blue Spinel, and Cobalt Chromite Blue-Green Spinel. Dark IR-reflective pigments representative of these types are available from both Shepherd Color Co. and the Ferro Corporation.

In one or more embodiments, IR-reflective (cool) and IR-transparent light- and dark-colored metal oxides, commonly used as pigments, may also be employed. These in amounts ranging from 0 PPT to 40 PPT. These may include, but are not limited to, Titanium Dioxide White, Chrome Titanate Yellow, Nickel Titanate Yellow, Zinc Ferrite Yellow, Red Iron Oxide, Yellow Iron Oxide, Chrome Oxide Green, Ultramarine Blue, and Cobalt Blue.

In one or more embodiments, the coarse titanium dioxide is a non-pigmentary TiO₂ commonly used in glass and ceramics manufacture. In one or more embodiments, the particle-size distribution may be 0-30% greater than 40 microns, in other embodiments greater than 30-60% greater than 20 microns, in other embodiments greater than 40-70% greater than 10 microns, and in other embodiments greater than 60-90% greater than 1 microns. This may be used in amounts ranging from 50 PPT to 150 PPT in the coating described in the invention. An example of TiO₂ suitable for manufacturing the roofing granules of the present invention is KRONOS GRADE 3025. Optionally, the +325 mesh fraction can be removed from the 3025 to optimize its performance.

In one or more embodiments, the TiO₂ is characterized by being white in color. In one or more embodiments, the TiO₂ has an L* value of at least 85, in other embodiments at least 90, in other embodiments at least 95, in other embodiments at least 96, in other embodiments at least 97, in other embodiments at least 97.5, in other embodiments at least 98, in other embodiments at least 98.5, in other embodiments at least 99, in other embodiments at least 99.5, in other embodiments at least 99.7, and in other embodiments at least 99.9. As those skilled in the art appreciated, the Color of base rock may be measured to determine L-value by using standard instrumentation such as Hunter L,a,b (Hunter Associates Laboratory, Inc., Reston, Va.) or CIELAB. Values for “L*” indicate the ratio of light to dark. Values for “a” refer to the redness-greenness coordinate in certain transformed color spaces, generally used as the difference in “a” between a specimen and a standard reference color. If “a” is positive, there is more redness than greenness; if “a” is negative, there is more greenness than redness. It is normally used with b as part of the chromaticity or chromaticity color difference. Values for “b” refer to the yellowness-blueness coordinate in certain color spaces, generally used as the difference in “b” between a specimen and a standard reference color, normally used with “a” or a as part of the chromaticity difference. Generally, if “b” is positive, there is more yellowness than blueness; if “b” is negative, there is more blueness than yellowness. For a description of the Hunter Color test methods, see Billmeyer, Jr. et al., PRINCIPLES OF COLOR TECHNOLOGY, John Wiley & Sons, 2^{ED} (1981), which is incorporated herein by reference.

In one or more embodiments, the steps in the manufacturing process of the roofing granules of the present invention may comprise one or more of the steps of: (a) crushing and sizing an aggregate (typically No. 11 grading); (b) preheating the crushed and sized aggregate to 93-115° C. (200-240° F.); and (c) coating the preheated granules with a semi-ceramic composition comprising (in PPT units): Water 40-60; Sodium silicate solution 55 to 100; (SiO₂/Na₂O=2.8-3.0, % by wt. solids=35.0-45.0); TiO₂ (Coarse) 50 to 150; IR-reflective dark pigments 10 to 50; IR-reflective tint pigments 0 to 40; and Kaolin clay 20 to 30. These components may be combined into a slurry using suitable mixing equipment. The slurry can then be applied to the preheated base aggregate in a suitable apparatus to produce uncured color-coated granules; pre-drying the uncured color-coated granules by adjusting the temperature and air flow to reduce their moisture content to between 0.2-0.5%; kiln-firing the uncured granules between 260° C. and 534° C. to form an insolubilized silicate-clay matrix in which the IR-reflective pigments and coarse titanium dioxide particles are uniformly distributed; cooling the fired, color-coated granules by means of air flow and/or water application in a suitable apparatus to reduce their temperature to 150° F.-250° F.; optionally applying a pickling agent such as 28% aluminum chloride or 30% magnesium chloride solution to aid coating insolubilization; and treating the finished granules with a mixture of process oil and an organosilicon compound to impart dust control and the improve asphalt adhesion.

In order to demonstrate the practice of the present invention, the following examples have been prepared and tested. The examples should not, however, be viewed as limiting the scope of the invention. The claims will serve to define the invention.

### EXAMPLES

Color, as measured by the Hunter L, a, and b system using standard equipment is listed for various base granules as set forth in Table 1. The higher L* values correspond to base granules generally appearing visually whiter. For the reference asphalt compound sample only, a ColorTec-PSM colorimeter was utilized to collect data.

TABLE 1

| Sample | L* | a* | b* |
|---|---|---|---|
| White printer paper | 94.85 | 0.53 | −2.77 |
| Asphalt (SBS | 14.2 | −2.44 | 15.68 |
| compound) | | | |
| Aluminum silicate | 92.57 | −0.51 | 9.2 |
| ceramic [1] | | | |
| Unknown [3] | 91.425 | −1.765 | 8.705 |
| Aluminum silicate | 88.140 | −0.745 | 6.860 |
| ceramic [2] | | | |
| Bone china [2] | 93.585 | −0.300 | 2.430 |
| Metamorphic rock | 47.215 | −0.915 | 3.585 |
| [10] | | | |
| Metamorphic rock | 46.590 | −1.360 | 2.655 |
| [11] | | | |
| Metamorphic rock | 47.125 | −2.295 | 3.640 |
| [12] | | | |
| Metamorphic | 46.030 | −2.390 | 5.115 |
| rock [13] | | | |
| White fused | 84.995 | −0.335 | 4.145 |
| alumina | | | |
| Tabular alumina | 92.355 | 0.295 | 0.140 |
| Fused silica | 82.850 | 0.270 | −1.385 |
| White fused mullite | 81.730 | 0.750 | 2.390 |
| Mullite (M60) | 89.745 | −0.765 | 6.635 |
| Mullite (M45) | 83.395 | −0.265 | 7.740 |

Solar reflectance values of various base granules were obtained using a commercial portable solar reflectometer Model No. SSR-E (Solar Spectrum Reflectometer Devices & Services) according to ASTM C1549 with air mass of 1.5; measurements are listed on Table 2.

Granules were coated as known in the art with a composition prepared in the laboratory using standard mixing equipment believed to include 25 g water, 60 g sodium silicate (grade 40), 15 g sodium silicate (grade 50 L), 60 g TiO₂ pigment, and 35.7 g kaolin clay slurry. This coating composition, or other similar thereto, was applied in a manner believed to include the equivalent of 2000 g of base granules preheated to 105° C. (220° F.). Pre-dried coated granules were then believed to be fired through a rotary kiln at 510° C. (950° F.). The resulting granules were white in color and uniformly coated. The solar reflectances of the coated granules were again measured using a commercial portable solar reflectometer as per ASTM C1549; results are shown on Table 2.

### Example 1

Asphalt panels about were prepared according to standard production line methods; samples were generally about 80 mil (2 mm) in thickness and were produced on glass or polyester scrim, using asphalt, SBS (about 5 to 8%) or aPP polymer (about 17 to 21%) and fillers (about 20 to 50%). The resultant asphalt panel had only 5.4% solar reflectance as measured per ASTM C1549 using a portable solar reflectometer.

### Example 2

Asphalt coating samples as noted in Example 1 were collected from the production line. The cooled sheets were heated in an oven at about 138° C. (280° F., for SBS compounds) or 160° C. (320° F., for aPP compounds) between 30 and 60 minutes. A heavy layer of granules was poured over the asphalt sheet surface (approximately 6″×6″ substrate), a release paper was placed over the granules, and then a plywood (12″×12″) piece placed over top. The granules were then press down manually with a pressure of about 6 psi over the plywood. After a few seconds, the plywood and the release paper were removed. The excess granules were removed from the surface by inverting the panel followed by gentle tapping. The sample panels were then once again measured for solar reflectance according to ASTM C1549; results are listed on Table 2. Delta reflectance values correspond to the difference between the values for reflectance of coated base granules and the values for panel reflectance.

TABLE 2

| Base | | Reflectance of base | Reflectance | | |
|---|---|---|---|---|---|
| Granules | Base Granule | granules/[Panel | of coated | Panel | Delta |
| Sample # | Material | reflectance of base] | base granules | reflectance | reflectance |
| 1 | Rhyolite/natural rocks | — | 0.46 | 0.41 | 0.05 |
| 2 | Unknown [1] | — | 0.705 | 0.53 | 0.175 |
| 3 | Marble/limestone [1] | — | 0.667 | 0.5 | 0.167 |
| 4 | Unknown [2] | — | 0.743 | 0.59 | 0.153 |
| 5 | Unknown [3] | 0.769 | 0.799 | 0.7 | 0.099 |
| 6 | Aluminum silicate | 0.79/[0.678] | — | 0.6~0.65 | — |
| | ceramic [1] | | | | |
| 7 | Aluminum silicate | — | 0.69~0.78 | 0.54~0.69 | — |
| | ceramic [2] | | | | |
| 8 | Unknown [4] | — | — | 0.60~0.64 | — |
| 9 | Metamorphic rock [1] | 0.186 | 0.411 | 0.398 | 0.013 |
| 10 | Metamorphic rock [2] | 0.186 | 0.526 | 0.509 | 0.017 |
| 11 | Metamorphic rock [3] | 0.167 | 0.557 | 0.523 | 0.034 |
| 12 | Metamorphic rock [4] | — | 0.56 | 0.53 | 0.03 |
| 13 | Metamorphic rock [5] | — | 0.66 | 0.59 | 0.07 |
| 14 | Metamorphic rock [6] | — | 0.49 | 0.47 | 0.02 |
| 15 | Metamorphic rock [7] | — | 0.475 | 0.489 | ~0.014 |
| 16 | Metamorphic rock [8] | — | 0.597 | 0.538 | 0.059 |
| 17 | Metamorphic rock [9] | — | 0.431 | 0.432 | ~0.001 |
| 18 | Bone china [1] | 0.8/[65.1] | ~0.69 | ~0.59 | — |
| 19 | Bone china [2] | 0.8/[65.1] | — | 0.53 | ~0.53 |
| 20 | Metamorphic rock [10] | 0.172/[0.165] | ~0.55 | ~0.49 | — |
| 21 | Metamorphic rock [11] | 0.167/[0.189] | ~0.59 | ~0.54 | — |
| 22 | Metamorphic rock [12] | 0.186/[0.162] | ~0.51 | ~0.50 | — |
| 23 | Metamorphic rock [13] | 0.1777/[0.17] | ~0.47 | ~0.45 | — |
| 24 | Marble/limestone [2] | — | 0.678 | — | 0.678 |
| 25 | Marble/limestone [3] | — | 0.72 | 0.56 | 0.16 |
| 26 | Marble/limestone [4] | — | 0.76 | 0.59 | 0.17 |
| 27 | White fused alumina | 0.748/[0.642] | 0.769 | 0.623 | 0.146 |
| 28 | Tabular alumina | 0.825/[0.61] | 0.793 | 0.699 | 0.094 |
| 29 | Fused silica | 0.661 | 0.770 | 0.588 | 0.182 |
| 30 | White fused mullite | 0.677/[0.316] | — | — | — |
| 31 | Mullite (M60) | 0.721/[0.640] | 0.731 | 0.649 | 0.082 |
| 32 | Mullite (M45) | 0.571/[0.473] | 0.698 | 0.641 | 0.057 |

Various modifications and alterations that do not depart from the scope and spirit of this invention will become apparent to those skilled in the art. This invention is not to be duly limited to the illustrative embodiments set forth herein.

What is claimed is:

1. A roofing article comprising:
an asphaltic substrate; and
a plurality of granules disposed on a surface of the substrate, said granules including a base rock and a coating, where the coating is characterized by a reflectivity, according to ASTM C1549, of at least 50%, an opacity of at least 50%, and is chemically inert, and where the base rock is characterized by a reflectivity of at least 50%, an opacity of at least 50%, and is chemically inert.

2. The article of claim 1, where the base rock is characterized by a panel reflectivity of at least 65% according to ASTM C1549.

3. The article of claim 1, where the base rock is characterized by a panel reflectivity of at least 66% according to ASTM C1549.

4. The article of claim 1, where the base rock is characterized by a panel reflectivity of at least 67% according to ASTM C1549.

5. The article of claim 1, where the base rock is characterized by a panel reflectivity of at least 68% according to ASTM C1549.

6. The article of claim 1, where the base rock is characterized by a panel reflectivity of at least 69% according to ASTM C1549.

7. The article of claim 1, where the article has a panel reflectivity of at least 65% according to ASTM C1549.

8. The article of claim 1, where the article has a panel reflectivity of at least 66% according to ASTM C1549.

9. The article of claim 1, where the article has a panel reflectivity of at least 67% according to ASTM C1549.

10. The article of claim 6, where the article has a panel reflectivity of at least 68% according to ASTM C1549.

11. The article of claim 6, where the article has a panel reflectivity of at least 69% according to ASTM C1549.

12. The article of claim 1, where differential between the reflectivity of the base rock and the panel reflectivity provided by the base rock is less than 12%.

13. The article of claim 11, where differential between the reflectivity of the base rock and the panel reflectivity provided by the base rock is less than 10%.

14. The article of claim 1, where differential between the reflectivity of the coated granules and the panel reflectivity provided by the coated granules is less than 12%.

15. The article of claim 11, where differential between the reflectivity of the coated granules and the panel reflectivity provided by the coated granules is less than 10%.

16. The article of claim 1, where the base rock is white.

17. The article of claim 16, where the base rock is characterized by L-value of at least 85.

18. The article of claim 17, where the coating on the base rock comprises TiO₂.

19. The article of claim 18, where the coating is characterized by an L-value of at least 90.

20. The article of claim 19, where the base rock includes mullite, crushed porcelain, alumina, tabular alumina, or grog.
